(19) United States
(12) Patent Application Publication
(10) Pub. No.: US 2019/0292341 A1
(43) Pub. Date: Sep. 26, 2019

(54) HYDROPHOBIC AND HYDROPHILIC SURFACES, ARTICLES AND METHODS OF MAKING SAME

(71) Applicant: The Board Of Regents Of The Nevada System Of Higher Education On Behalf Of The University Of Nevada,, Las Vegas, NV (US)

(72) Inventors: Kwang Kim, Henderson, NV (US); Tae Seon Hwang, Las Vegas, NV (US)

(21) Appl. No.: 16/306,449

(22) PCT Filed: Jun. 5, 2017
(86) PCT No.: PCT/US2017/035943

§ 371 Date: Nov. 30, 2018

Related U.S. Application Data
(60) Provisional application No. 62/350,087, filed on Jun. 14, 2016.

(51) Int. Cl. C08J 7/00

(52) U.S. Cl. CPC C08J 7/00; C08J 2323/12; C08J 2481/06; C08J 2423/06; C08J 2427/18

(57) ABSTRACT

The invention generally relates to articles and methods of making thereof. More specifically, the invention generally relates to articles comprising a substrate embedded with particles, and having at least one etched surface exposing at least a portion of particles. Methods of making these articles are also disclosed. This abstract is intended as a scanning tool for purposes of searching in the particular art and is not intended to be limiting of the present invention.

### CROSS-REFERENCE TO RELATED APPLICATIONS

This application claims benefit of U.S. Provisional Application No. 62/350,087, filed on Jun. 14, 2016, which is hereby incorporated by reference in its entirety.

### BACKGROUND

Hydrophobic and hydrophilic surfaces are known. However, the rapid development of consumer electronics, medical devices and delivery systems, automobile industry, solar industry and the like, has opened new avenues for the use of these surfaces. Hydrophobic and hydrophilic surfaces possess unique properties, such as self-cleaning, anti-fogging, anti-sticking, and anti-contamination, that make their application very attractive to numerous industries.

During the last few decades, considerable efforts were made to develop methods of forming unique hydrophobic and hydrophilic surfaces. Conventionally, hydrophobic/hydrophilic surfaces are fabricated either by roughening the surface of low (or high)-surface energy materials or lowering (or increasing) the surface energy of rough surfaces. It was also found that some materials, when applied to a substrate surface, can significantly change the hydrophobic/hydrophilic properties of the surface. For example, fluorocarbon polymers are known to possess hydrophobic properties, and when deposited as a film or used as a bulk polymer, can provide hydrophobic surfaces due to their extremely low surface energies.

One of the challenges for product durability, however, is environmental exposure to a variety of agents, including, for example, dust, moisture, water, oils, and various chemicals. To extend the life time of the product, in some instances, the surface of these materials can be treated to provide more corrosion-resistant, wear-resistant, heat-resistant, or self-cleaning products.

Conventional methods for changing the physical, mechanical, and/or chemical properties of the material surface are, in general, directed to modifications of the material surface without affecting the bulk of the material. For example, formation of hydrophobic/hydrophilic surfaces usually includes a chemical coating of the surface. Other approaches can include a solution-based etching or plasma etching to provide a desired roughness of the surface, and thus, control the hydrophobicity or hydrophilicity of the surface. However, the hydrophobic/hydrophilic properties formed by these methods usually require multiple processing steps, are not durable enough, and cannot be maintained over a long period time.

Thus, there remains a need for improved materials having sustainable hydrophobic/hydrophilic properties. Still further, there is a need for methods of making materials and articles having improved hydrophobic/hydrophilic surfaces. These needs and others are met by the present invention.

### SUMMARY

In accordance with the purpose(s) of the invention, as embodied and broadly described herein, the invention, in one aspect, relates to articles comprising a substrate embedded with particles, wherein the substrate has at least one etched surface exposing at least a portion of the particles.

In yet other aspects, the invention relates to articles comprising a substrate having particles extending from a surface of the substrate.

Also disclosed are methods comprising etching a surface of an article comprising particles embedded in a substrate.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE DRAWINGS

The accompanying figures, which are incorporated in and constitute a part of this specification, illustrate several aspects and together with the description serve to explain the principles of the invention.

FIG. 1A and FIG. 1B depict representative interaction schematics of exemplary hydrophilic (1A) and hydrophobic (1B) surfaces with a water droplet.

FIG. 2A and FIG. 2B depict a representative schematic of methods of making inventive articles by forming the composite by injection molding or extrusion (2A) or etching the article to expose particles on the article's surface (2B).

FIG. 3A-D depict representative photographs of articles prepared from a polypropylene (PP) plastic matrix embedded with various concentrations of hydrophobic polytetrafluoroethylene (PTFE) particles. Specifically, articles prepared from a PP plastic matrix embedded with 0 wt % PTFE (PPT0) (3A), 1 wt % PTFE (PPT1) (3B), 5 wt % PTFE (PPT5) (3C), or 10 wt % PTFE (PPT10) (3D) are shown.

FIG. 4 depicts a representative thermogravimetric analysis (TGA) of the article PPT10.

FIG. 5 depicts representative Fourier Transform Infrared Spectroscopy (FT-IR) images of the articles PPT0, PPT1, PPT5, and PPT10.

FIG. 6A and FIG. 6B depict representative Scanning Electron Microscopy (SEM) images of the articles PPT0, PPT1, PPT5, and PPT10 prior to etch (6A) and after etch with a trichloroethylene solvent (TCE) (6B).

FIG. 7A and FIG. 7B depict representative water contact angle (WCA) images of the exemplary articles PPT0, PPT1, PPT5, and PPT10 prior to etch (7A) and after etch with a trichloroethylene solvent (TCE) (7B).

FIG. 8A and FIG. 8B depict representative images of casted pristine polysulfone (PSf) (8A) and a prepared PSf/PTFE composite (8B).

FIG. 9A-C depict representative WCA images of casted pristine PSf (9A), a prepared PSf/PTFE composite (9B), and a surface etched PSf/PTFE composite (9C).

FIG. 10A and FIG. 10B depict representative images of pristine low-density polyethylene (LDPE) (10A) and a prepared LDPE/PTFE composite (10B).

FIG. 11A-C depict representative WCA images of casted pristine LDPE (11A), a prepared LDPE/PTFE composite (11B), and a surface etched LDPE/PTFE composite (11C).

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

As used herein, nomenclature for compounds, including organic compounds, can be given using common names, IUPAC, IUBMB, or CAS recommendations for nomenclature.

As used in the specification and the appended claims, the singular forms “a,” “an” and “the” include plural referents unless the context clearly dictates otherwise. Thus, for example, reference to “a functional group,” “a particle,” or “a polymer” includes mixtures of two or more such functional groups, particles, or polymers, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. % or wt %) of a component, unless specifically stated to the contrary, is based on the total weight of the formulation or composition in which the component is included.

All percentages, ratios and proportions herein are by weight, unless otherwise specified. All temperatures are in degrees Celsius (° C.) unless otherwise specified.

Throughout the description and claims of this specification the word “comprise” and other forms of the word, such as “comprising” and “comprises,” means including but not limited to, and is not intended to exclude, for example, other additives, components, integers, or steps.

As used herein, the term “substantially” means that the subsequently described event or circumstance completely occurs or that the subsequently described event or circumstance generally, typically, or approximately occurs. For example, when the specification discloses that substantially homogeneous distribution of particles, a person skilled in the relevant art would readily understand that the particles need not be completely homogeneously distributed. Rather, this term conveys to a person skilled in the relevant art that the particles are homogeneously distributed to an extent that can be measured or provide a desirable results.

As a further example, when the specification discloses that a composition is “substantially free” of a component, for example, a person skilled in the relevant art would readily understand that the composition need not be completely free of the disclosed component (i.e., the component need not be completely absent from the composition). Rather, this term conveys to a person skilled in the relevant art that the component need only be present in a technically insignificant amount or concentration. In certain aspects, a composition is “substantially free” of a component when present in less than an amount or concentration less than that necessary to alter the basic and novel properties of the composition. To that end, for example, when an aspect is described as “substantially free” of a component, the aspect can have no more than 0.01%, 0.05%, 0.1%, 0.2%, 0.5%, 1%, 2%, 3%, 4%, 5%, 6%, 10%, 20%, 40%, 50%, or 60% of the component, relative to the total mass of the aspect, or in the alternative, relative to the mass of a composition thereof.

As used herein, the term “contact angle” (e.g., water contact angle) refers to an angle, conventionally measured with various liquids, where a liquid-vapor interface meets a solid surface. It is known that the theoretical description of contact arises from the consideration of a thermodynamic equilibrium between the three phases: the liquid phase (L), the solid phase (S), and the gas or vapor phase (G) (which could be a mixture of ambient atmosphere and an equilibrium concentration of the liquid vapor). It is further understood that in some aspects, “gaseous” phase can be replaced by another immiscible liquid phase. Commonly the solid-vapor interfacial energy is denoted γ_{SG} the solid-liquid interfacial energy γ_{SL}, and the liquid-vapor interfacial energy (i.e. the surface tension) is denoted γ_{LG}. Contact angle θ_{C} quantifies the wettability of a solid surface by a liquid via the Young equation:

γ_{SG}−γ_{SL}−γ_{LG} cos θ_{C}=0

A given system of solid, liquid, and vapor at a given temperature and pressure has a unique equilibrium contact angle. In the aspects, wherein the liquid is water, the measured contact angle is defined as a water contact angle. It is understood that the equilibrium contact angle reflects the relative strength of the liquid, solid, and vapor molecular interaction. The water contact angle is measured between 0°<θ_{C}<180°.

As used herein, the term “hydrophilic” refers to a surface or a particle that has affinity to water molecules. For example, a hydrophilic surface can have a water contact angle of less than 90°, less than 80°, less than 70°, less than 60°, less than 50°, less than 40°, less than 30°, less than 20°, or less than 10°.

As used herein, the term “hydrophobic” refers to a surface or a particle that tends to repel water molecules. For example, a hydrophobic surface can have a water contact angle of greater than 90°, greater than 100°, greater than 110°, greater than 120°, greater than 130°, greater than 140°, greater than 150°, greater than 160°, or greater than 170°.

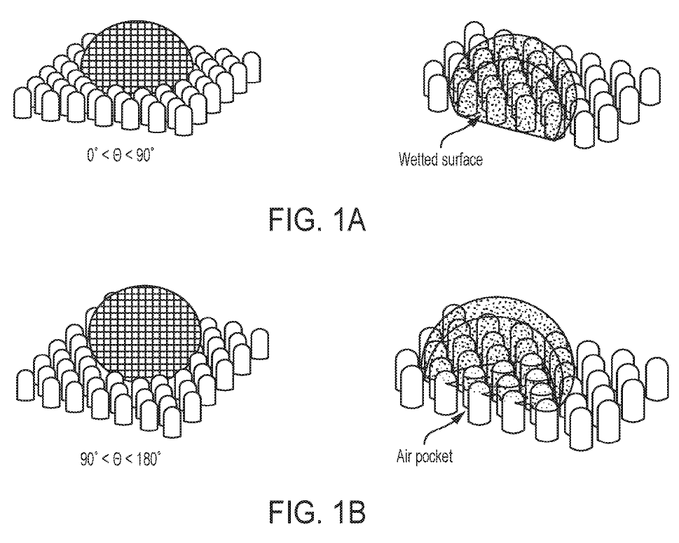

As used herein, the term “hydrophilic surface” refers to a surface having a water contact angle of less than about 90°. See, e.g., FIG. 1A.

As used herein, the term “hydrophobic surface” refers to a surface having a water contact angle of greater than about 90°. See, e.g., FIG. 1B.

As used herein, the term “superhydrophobic surface” refers to a surface having a water contact angle of greater than about 150°.

As used herein, the term “superhydrophilic surface” refers to a surface having a water contact angle of less than about 5°.

As used herein, the terms “optional” or “optionally” means that the subsequently described event or circumstance can or cannot occur, and that the description includes instances where said event or circumstance occurs and instances where it does not.

As used herein, the term “polymer” refers to a relatively high molecular weight organic compound, natural or synthetic, whose structure can be represented by a repeated small unit, the monomer (e.g., polyethylene, polypropylene, rubber, cellulose). Synthetic polymers are typically formed by addition or condensation polymerization of monomers.

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “oligomer” refers to a relatively low molecular weight polymer in which the number of repeating units is between two and ten, for example, from two to eight, from two to six, or from two to four. In one aspect, a collection of oligomers can have an average number of repeating units of from about two to about ten, for example, from about two to about eight, from about two to about six, or from about two to about four.

As used herein, the term “molecular weight” (MW) refers to the mass of one molecule of that substance, relative to the unified atomic mass unit u (equal to 1/12 the mass of one atom of carbon-12).

As used herein, the term “number average molecular weight” (Mₙ) refers to the common, mean, average of the molecular weights of the individual polymers. Mₙ can be determined by measuring the molecular weight of n polymer molecules, summing the weights, and dividing by n. Mₙ is calculated by:

$${\overline{M}}_{n} = \frac{{\sum }_{i} {N}_{i} {M}_{i}}{{\sum }_{i} {N}_{i}} ,$$

wherein Nᵢ is the number of molecules of molecular weight Mᵢ. The number average molecular weight of a polymer can be determined by gel permeation chromatography, viscometry (Mark-Houwink equation), light scattering, analytical ultracentrifugation, vapor pressure osmometry, end-group titration, and colligative properties.

As used herein, the term “weight average molecular weight” (M_{w}) refers to an alternative measure of the molecular weight of a polymer. M_{w} is calculated by:

$${\overline{M}}_{w} = \frac{{\sum }_{i} {N}_{i} {M}_{i}^{2}}{{\sum }_{i} {N}_{i} {M}_{i}} ,$$

wherein Nᵢ is the number of molecules of molecular weight Mᵢ. Intuitively, if the weight average molecular weight is w, and a random monomer is selected, then the polymer it belongs to will have a weight of w on average. The weight average molecular weight can be determined by light scattering, small angle neutron scattering (SANS), X-ray scattering, and sedimentation velocity.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, the term or phrase “substantially uniform particle size” refers to the particle size describing particles, wherein at least 90% of the mass of a material is made up of particles having a particle size in the range 1X-4X. In this aspect, the term refers to particles, wherein for at least 90% of the mass of material, the smallest particles are no smaller than ¼ of the large particle size. In a further aspect, the term refers to particles, wherein for at least 90% of the mass of material, the largest particles are no more than 4 times larger than the small particles.

As used herein particle size distribution characteristics to be replicated can include predetermined values of D₍ₙ₎, where (n) represents a mass percentage such as 5%, 10%, 15%, 20%, 25%, 30%, 35%, 40%, 45%, 50%, 55%, 60%, 65%, 70%, 75%, 80%, 85%, 90%, 95%, or 100%. The value of D₍ₙ₎, thus represents the particle size of which (n) percentage of the mass is finer than. For example, the quantity D₍₁₀₀₎ represents the particle size of which 100% of a mass is finer than. The quantity D₍₇₅₎ represents the particle size of which 75% of a mass is finer than. The quantity D₍₅₀₎ is the median particle size of a mass for which 50% of the mass is finer than. The quantity D₍₂₅₎ represents the particle size of which 25% of a mass is finer than. The quantity D₍₁₀₎ represents the particle size of which 10% of a mass is finer than.

As used herein, the term “derivative” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds. Exemplary derivatives include salts, esters, amides, salts of esters or amides, and N-oxides of a parent compound.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

The term “aliphatic” or “aliphatic group,” as used herein, denotes a hydrocarbon moiety that may be straight-chain (i.e., unbranched), branched, or cyclic (including fused, bridging, and spirofused polycyclic) and may be completely saturated or may contain one or more units of unsaturation, but which is not aromatic. Unless otherwise specified, aliphatic groups contain 1-20 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

As defined herein, the term “polyolefin” refers to any class of polymers produced from a simple olefin (also called an alkene with the general formula CₙF₂ₙ) as a monomer. In some aspects, the polyolefins which can be used as a polymeric substrate include, but are not limited to, polyethylene, polypropylene, both homopolymer and copolymers, poly(l-butene), poly(3-methyl-1-butene), poly(4-methyl-1-pentene) and the like, as well as combinations or mixtures of two or more of the foregoing.

The term “polyamide,” as utilized herein, is defined to be any long-chain polymer in which the linking functional groups are amide (—CO—NH—) linkages. The term polyamide is further defined to include copolymers, terpolymers and the like as well as homopolymers and also includes blends of two or more polyamides. In some aspects, polyamide based polymeric substrate can comprise one or more of nylon 6, nylon 66, nylon 10, nylon 612, nylon 12, nylon 11, or any combination thereof.

The term “polyester polymer” as utilized herein, refers to a polymer comprising a long-chain synthetic polymer composed of at least 85% by weight of an ester of a substituted aromatic carboxylic acid, including but not restricted to substituted terephthalic units, p(—R—O—CO— C₆H₄—CO—O—)ₓ and parasubstituted hydroxy-benzoate units, p(-R—O—CO—C₆H₄—O)ₓ. In some aspects, the polyester substrate comprise polyethylene terephthalate (PET) homopolymers and copolymers, polybutylene terephthalate (PBT) homopolymers and copolymers, and the like, including those that contain comonomers such as cyclohexanedimethanol, cyclohexanedicarboxylic acid, and the like.

The term “polystyrene” refers to any class of polymers produced from a simple styrene monomer. Polystyrenes described herein can include both syndiotactic and atactic polystyrenes. Polystyrenes described herein can also comprise expanded polystyrenes and extruded polystyrenes. In some aspects, the polystyrenes described herein can comprise copolymers. In exemplary aspects, styrene monomer can be polymerized with a different monomer to form a graft polymer. Examples of these graft polymers include but are not limited to styrene-butadiene polymer, acrylonitrile-butadiene-styrene, and the like.

The terms “polyetherimide” or “PEI” as referred herein can be used interchangeably and relate to a polymer containing cyclic imides and ether units in the backbone. PEI is categorized as a special class of polyimide (PI) which is a condensation polymer derived from bifunctional carboxylic anhydrides and primary diamines.

The term “polyetherketone” as referred herein relates to a family of high-performance thermoplastic polymers, consisting of an aromatic backbone molecular chain interconnected by ketone and ether functional groups.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B—F, C-D, C-E, and C—F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. ARTICLE

In certain aspects, disclosed herein is an article comprising a substrate embedded with particles, wherein the substrate has at least one etched surface exposing at least a portion of the particles. In yet other aspects, disclosed herein is an article comprising a substrate having particles extending from a surface of the substrate. In still further aspects, the article disclosed herein can be any article known in the art. In some aspects, the article is not a film. In other aspects, the articles can comprise, for example and without limitation, electronic devices, biological analytical and diagnostic tools, optical devices, consumable plastic good, toys, cosmetic cases, protect sheets, paint, and the like.

1. Substrate

Disclosed herein is an article comprising a substrate. In some aspects, the substrate comprises at least one etched surface. In yet other aspects, the etched surface exposes at least a portion of the particles. In some aspects, the substrate can comprise more than one etched surfaces. It is understood that if more than one surface of the substrate is etched, the at least a portion of the particles exposed on each surface can be the same or different, and it can depend on a specific application of the article.

In certain aspects, the substrate of the disclosed article can be any substrate known in the art. In some aspects, the substrate can comprise a metal, a polymer, a wood, a textile, a glass, a ceramics, a metal alloy, a metal oxide, and the like. In some aspects, the substrate can comprise one or more foregoing materials. In yet other aspects, the substrate can comprise a polymer. In still further aspects, the substrate is a polymeric substrate.

In the aspects, wherein the substrate is a polymer, the polymeric substrate can comprise any known in the art polymers having desirable properties for a specific article's application. It is further understood that in some aspects, a specific polymeric substrate can be chosen by one of ordinary skill in the art based on the desired functionalities and properties of the disclosed article. In a further aspect, the polymeric substrate comprises polypropylene (PP), low-density polyethylene (LDPE), high-density polyethylene(HDPE), polystyrenes (PS), acrylonitrile butadiene styrene (ABS), polyethylene terephthalate (PET), polyethylene (PE), polysulfone (PSf), or any combination thereof.

In one aspect, the substrate can comprise a thermoplastic polymer. In yet another aspect, the substrate can comprise a thermosetting polymer. In a still further aspect, the substrate can comprise a blend of thermoplastic and thermosetting polymers. It is further understood that any thermoplastic polymer can also be a blend of polymers, copolymers, terpolymers, or combinations including at least one of the foregoing organic polymers. In one aspect, examples of the organic polymer are polyethylene (PE), including high-density polyethylene (HDPE), linear low-density polyethylene (LLDPE), low-density polyethylene (LDPE), mid-density polyethylene (MDPE), glycidyl methacrylate modified polyethylene, maleic anhydride functionalized polyethylene, maleic anhydride functionalized elastomeric ethylene copolymers, ethylene-butene copolymers, ethylene-octene copolymers, ethylene-acrylate copolymers, such as ethylene-methyl acrylate, ethylene-ethyl acrylate, and ethylene butyl acrylate copolymers, glycidyl methacrylate functionalized ethylene-acrylate terpolymers, anhydride functionalized ethylene-acrylate polymers, anhydride functionalized ethylene-octene and anhydride functionalized ethylene-butene copolymers, polypropylene (PP), maleic anhydride functionalized polypropylene, glycidyl methacrylate modified polypropylene, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polyoxymethylenes, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyurethanes, or the like, or a combination including at least one of the foregoing organic polymers.

Specific non-limiting examples of blends of thermoplastic polymers can include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations including at least one of the foregoing blends of thermoplastic polymers.

In some exemplary aspects, the polymeric substrate can comprise polymers derived from polyolefins, polyamides, polyesters, polystyrenes, polyetherimides, polyethersulfones, polyetherketones, ethylene vinyl alcohol, polyvinylidene chloride, epoxy, polysulfones, or any combinations thereof.

In some aspects, the substrate comprises polyolefins. In some aspects, the polyolefins can comprise homogeneously branched and linear polyethylenes. Homogeneously branched ethylene polymer is homogeneous ethylene polymer that refers to an ethylene polymer in which the monomer or comonomer is randomly distributed within a given polymer or interpolymer molecule and wherein substantially all of the polymer or interpolymer molecules have substantially the same ethylene to comonomer molar ratio with that polymer or interpolymer.

It is understood that the terms “homogeneous linearly branched ethylene polymer” or “homogeneously branched linear ethylene/α-olefin polymer” do not refer to high pressure branched polyethylene which is known to those skilled in the art to have numerous long chain branches. The term “homogeneous linear ethylene polymer” generically refers to both linear ethylene homopolymers and to linear ethylene/α-olefin interpolymers. A linear ethylene/α-olefin interpolymer possesses short chain branching and the α-olefin is typically at least one C₃-C₂₀ α-olefin (e.g., propylene, 1-butene, 1-pentene, 4-methyl-1-pentene, 1-hexene, and 1-octene). In other aspects the polyethylenes that are suitable for use in the present invention are interpolymers of ethylene with at least one C₃-C₂₀ α-olefin and/or C₄-C₁₈ diolefin. Copolymers of ethylene and α-olefin of C₃-C₂₀ carbon atoms can be used.

The term “interpolymer” is used herein to indicate a copolymer, or a terpolymer, or the like, where at least one other comonomer is polymerized with ethylene to make the interpolymer. Suitable unsaturated comonomers useful for polymerizing with ethylene include, for example, ethylenically unsaturated monomers, conjugated or non-conjugated dienes, polyenes, etc. Examples of such comonomers include C₃-C₂₀ α-olefins as propylene, isobutylene, 1-butene, 1-hexene, 4-methyl-1-pentene, 1-heptene, 1-octene, 1-nonene, 1-decene, 1,9-decadiene and the like. Other suitable monomers include styrene, halo- or alkyl-substituted styrenes, tetrafluoroethylene, vinylbenzocyclobutane, 1,4-hexadiene, 1,7-octadiene, and cycloalkenes, e.g., cyclopentene, cyclohexene and cyclooctene.

In yet other aspects, the polyolefins can comprise heterogeneously branched ethylene polymers having a distribution of branching different from and broader that the homogeneous branching ethylene/α-olefin interpolymer at similar molecular weight. In further aspects, the “heterogeneous” and “heterogeneously branched” mean that the ethylene polymer is characterized as a mixture of interpolymer molecules having various ethylene to comonomer molar ratios.

In yet other aspects, the polyolefins can comprise ultra-low density polyethylene (“ULDPE”), very low density polyethylene (“VLDPE”), linear low density polyethylene (“LLDPE”) medium density polyethylene (“MDPE”) or high density polyethylene (“HDPE”).

In still other aspects, the polyolefin based polymeric substrate can comprise free-radical initiated highly branched high pressure low density ethylene homopolymer and ethylene interpolymers such as, for example, ethylene-acrylic acid (EAA) copolymers and ethylene-vinyl acetate (EVA) copolymers, in that substantially linear ethylene polymers do not have equivalent degrees of long chain branching and are made using single site catalyst systems rather than free-radical peroxide catalyst systems.

In one aspect, the polyolefins include, but are not limited to, polyethylene, polypropylene, both homopolymer and copolymers, poly(l-butene), poly(3-methyl-1-butene), poly(4-methyl-1-pentene) and the like as well as combinations or mixtures of two or more of the foregoing. In yet other aspects, the polyolefins can comprise polypropylene (PP), low-density polyethylene (LDPE), high-density polyethylene (HDPE), or any combination thereof.

In some aspects, the polyolefins disclosed herein can have a molecular weight of at least about 1,000. In yet other aspects, the polyolefins disclosed herein can have a molecular weight of at least about 50,000. In still other aspects, the polyolefins disclosed herein can have a molecular weight of from about 150,000 to about 500,000. However, it should be understood that polyolefins having a greater molecular weight may be used where suitable.

In one aspect, the substrate can comprise polysulfones. Polysulfone is a tough, rigid, high strength transparent thermoplastic, which maintains its properties over a wide temperature range of from about −150° F. to greater than about 300° F. Polysulfone also offers a high dimensional stability—changes in linear dimensions after exposure to boiling water or air at 300° F. are generally of about 1/10 of 1% or less. Without wishing to be bound by theory, these properties may make polysulfone a desirable substrate component, although other desirable properties may also be present.

In certain aspects, the substrate can comprise polyamides. In some aspects, polyamides can comprise one or more of nylon 6, nylon 66, nylon 10, nylon 612, nylon 12, nylon 11, or any combinations thereof.

In still further aspects, the substrate can comprise polyesters. In certain aspects, the polyesters can comprise terephthalate based esters. In yet other aspects, the polyester can comprise polyethylene terephthalate (PET) homopolymers and copolymers, polypropylene terephthalate (PPT/PTT) homopolymers and copolymers, polybutylene terephthalate (PBT) homopolymers and copolymers, and the like, including those that contain comonomers such as cyclohexanedimethanol, cyclohexanedicarboxylic acid, and the like. In further aspects, the polyester can comprise polyethylene terephthalate glycol modified (PETG). In yet other aspects, the polyester can comprise a crystalline polyethylene terephthalate (CPET). In still further aspects, the polyester can comprise a polycyclohexylenedimethylene terephthalate (PCT) or glycol modified polycyclohexylenedimethylene terephthalate (PCTG). In still further aspects, the polyester can comprise polyethylene terephthalate, polypropylene terephthalate, polybutylene terephthalate, or any combinations thereof.

In certain aspects, the polymeric substrate can comprise a polystyrene polymer. In yet other aspects, the polystyrenes described herein can be formed from a vinyl aromatic monomer having the formula: H₂C═CR—Ar—, wherein R is hydrogen or an alkyl group having from 1 to 4 carbon atoms and Ar is an aromatic group (including various alkyl and halo-ring-substituted aromatic units) having from about 6 to about 10 carbon atoms. In some exemplary aspects, the monomers can include, without limitation, styrene, alpha-methylstyrene, ortho-methylstyrene, meta-methylstyrene, para-methylstyrene, para-ethylstyrene, isopropenyltoluene, isopropenylnaphthalene, vinyl toluene, vinyl naphthalene, vinyl biphenyl, vinyl anthracene, the dimethylstyrenes, t-butylstyrene, the several chlorostyrenes (such as the mono- and dichloro-variants), and the several bromostyrenes (such as the mono-, dibromo- and tribromo-variants), and the like. According to one aspect of the present invention, the monomer is styrene. In some aspects, the polystyrenes disclosed herein can have a molecular weight of at least about 1,000. In yet other aspects, the polystyrenes disclosed herein can have a molecular weight of at least about 50,000. In still other aspects, the polystyrenes disclosed herein can have a molecular weight of from about 150,000 to about 500,000. However, it should be understood that polystyrenes having a greater molecular weight may be used where suitable.

In yet other aspects, the polymeric substrate can be a graft polymer. In certain aspects, the polymeric substrate can comprise an acrylonitrile-butadiene-styrene polymer (ABS), an acrylonitrile-styrene-butyl acrylate (ASA) polymer, a methyl methacrylate-acrylonitrile-butadiene-styrene (MABS) polymer, a methyl methacrylate-butadiene-styrene (MBS) polymer, and an acrylonitrile-ethylene-propylene-diene-styrene (AES) polymer.

In still further aspects, the substrate can comprise polyketones. In some aspects polyketones can comprise a polyaryletherketone. In still further aspects, polyaryletherketones can comprise any polyaryletherketone material or mixture of materials, for example, polyetheretherketone (PEEK), polyetherketone (PEK), polyetherketoneketone (PEKK), polyetherketoneetherketoneketone (PEKEKK), or polyetheretherketoneketone (PEEKK), or a combination thereof. In certain aspects, polyetheretherketone can include polyetheretherketone co-polymers. In another aspect, the substrate can comprise polyetheretherketone homopolymer.

In some aspects, the substrate can comprise polyetherimides. The polyetherimide can be selected from (i) polyetherimide homopolymers, e.g., polyetherimides, (ii) polyetherimide co-polymers, e.g., polyetherimidesulfones, and (iii) combinations thereof. Polyetherimides are known polymers and are sold by SABIC under the ULTEM®*, EXTEM®*, and Siltem* brands (Trademark of SABIC Innovative Plastics IP B.V.).

In yet other aspects, the polymeric substrate can comprise polypropylene (PP), low-density polyethylene (LDPE), high-density polyethylene (HDPE), polystyrenes (PS), acrylonitrile butadiene styrene (ABS), polyethylene terephthalate (PET), polyethylene (PE), polysulfone (PSf), or any combination thereof

2. Particles

In some aspects, the article disclosed herein comprises particles embedded in the substrate. In some aspects, the particles comprise a plurality of particles.

In certain aspects, particles can occupy at least about 10% of the substrate by volume, at least about 20% of the substrate by volume, at least 30% of the substrate by volume, at least about 40% of the substrate by volume, at least about 50%% of the substrate by volume, at least about 60% of the substrate by volume, at least about 70% of the substrate by volume, at least about 80% of the substrate by volume, or at least about 90% of the substrate by volume.

In yet other aspects, the surface density of the particles embedded in the substrate is from about 0.01 to about 10.0 g/cm², including exemplary values of about 0.05 g/cm², about 0.1 g/cm², about, about 1.5 g/cm², about 2.0 g/cm², about 2.5 g/cm², about 3.0 g/cm², about 3.5 g/cm², about 4.0 g/cm², about 4.5 g/cm², about 5.0 g/cm², about 5.5 g/cm², about 6.0 g/cm², about 6.5 g/cm², about 7.0 g/cm², about 7.5 g/cm², about 8.0 g/cm², about 8.5 g/cm², about 9.0 g/cm², and about 9.5 g/cm². It is further understood that the surface density of the particles embedded in the substrate can have any value between any two foregoing values.

It is understood that particles can be present in any size chosen by one of skilled in the art. In some aspects, the particles are microparticles. In other aspects, the particles are nanoparticles. In certain aspects, particles are present both as microparticles and nanoparticles. In some aspects, particles size is from about 1 nm to about 200 μm, including exemplary values of about 5 nm, about 10 nm, about 20 nm, about 50 nm, about 100 nm, about 200 nm, about 300 nm, about 400 nm, about 500 nm, about 600 nm, about 700 nm, about 800 nm, about 900 nm, about 1 μm, about 5 μm, about 10 μm, about 20 μm, about 30 μm about 40 μm, about 50 μm, about 60 μm, about 70 μm, about 80 μm, about 90 μm, about 100 μm, about 110 μm, about 120 μm, about 130 μm about 140 μm about 150 μm, about 160 μm, about 170 μm, about 180 μm, and about 190 μm. It is understood that the particles size can have any value between any two foregoing values. For example and without limitation particles size can be from about 1 nm to about 50 nm, or from about 30 nm to about 150 nm, or from about 10 nm to about 900 nm, or from about 50 nm to about 5 μm, or from about 20 μm to about 150 μm.

In yet other aspects, the particles can be homogeneously distributed in the substrate. In yet still other aspects, the particles can be substantially homogeneously distributed in the substrate. In yet other aspects, the particles can have a substantially homogeneous particle size. In still further aspects, the particles can have a random particle size.

In certain aspects, the particles embedded in the surface can have a D₍₁₀₀₎ value of about 200 μm, about 100 μm, about 50 μm, about 1 μm, about 500 nm, about 200 nm, about 100 nm, or about 50 nm. In other aspects, the particles embedded in the surface can have D₍₇₅₎ value of about 200 μm, about 100 μm, about 50 μm, about 1 μm, about 500 nm, about 200 nm, about 100 nm, or about 50 nm. In yet other aspects, the particles embedded in the surface have a D₍₅₀₎ value of 200 μm, about 100 μm, about 50 μm, about 1 μm, about 500 nm, about 200 nm, about 100 nm, or about 50 nm.

In certain aspects, the particles are hydrophobic. Thus, in various aspects, the particles comprise polytetrafluoroethylene particles, hydrophobic silica particles, titanium dioxide particles, or any combination thereof.

In certain aspects, the particles are hydrophilic. Thus, in various aspects, the particles comprise hydrophilic silica, titanium dioxide, polysilzane, or any combination thereof.

In certain aspects, and depending on the surrounding environment or methods of preparation, the particles can behave as hydrophobic or hydrophilic.

In certain aspects, particles are embedded in the polymeric substrate, wherein the polymeric substrate and the particles can have different hydrophobic properties. In these aspects, the hydrophobic properties of the particles are at least about 5%, at least about 10%, at least about 20%, at least about 30%, at least about 40%, at least about 50%, at least about 60%, at least about 70%, at least about 80%, at least about 90%, at least about 95%, at least 100%, or at least about 200% greater than the initial hydrophobic properties of the polymeric substrate.

In certain aspects, particles are embedded in the polymeric substrate, wherein the polymeric substrate and the particles can have different hydrophobic properties. In these aspects, the hydrophobic properties of the particles are at least about 5%, at least about 10%, at least about 20%, at least about 30%, at least about 40%, at least about 50%, at least about 60%, at least about 70%, at least about 80%, at least about 90%, or at least about 95% less than the initial hydrophobic properties of the polymeric substrate.

In certain aspects, particles are embedded in the polymeric substrate, wherein the polymeric substrate and the particles can have different hydrophilic properties. In these aspects, the hydrophilic properties of the particles are at least about 5%, at least about 10%, at least about 20%, at least about 30%, at least about 40%, at least about 50%, at least about 60%, at least about 70%, at least about 80%, at least about 90%, at least about 95%, at least 100%, or at least about 200% greater than the initial hydrophilic properties of the polymeric substrate.

In certain aspects, particles are embedded in the polymeric substrate, wherein the polymeric substrate and the particles can have different hydrophilic properties. In these aspects, the hydrophilic properties of the particles are at least about 5%, at least about 10%, at least about 20%, at least about 30%, at least about 40%, at least about 50%, at least about 60%, at least about 70%, at least about 80%, at least about 90%, or at least about 95% less than the initial hydrophilic properties of the polymeric substrate.

It is understood that particles can comprise any particles known in the art that have hydrophobic or hydrophilic properties. In yet other aspects, the particles can comprise any particles known in the art that have hydrophobic properties. In still other aspects, the particles can comprise any particles known in the art that have hydrophilic properties. In some aspects, the particles can comprise polytetrafluoroethylene particles, hydrophobic silica particles, titanium dioxide particles, graphene, boron nitride, or any combination thereof. In yet still other aspects, the particle can comprise hydrophilic silica, titanium dioxide polysilzane, graphene oxide, or any combination thereof.

In some aspects, the disclosed article has a surface roughness. It is understood that the surface roughness is a component of a surface texture. In some aspects, a degree of the surface roughness can be controlled by one of ordinary skill in the art. In certain aspects, the surface roughness is predetermined by a specific application of the article. In some aspects, the surface roughness can be quantified by the deviations in the direction of the normal vector of a real surface from its ideal form. It is understood that in the aspects the deviations are large, the surface is considered to be rough. In the aspects, wherein the deviations are small, the surface is considered to be smooth. In some aspects, surface roughness can determine the interaction of the article with the surrounding environment. In other aspects, the surface roughness can determine if the article surface is a hydrophilic or hydrophobic surface.

In yet other aspects, the surface roughness can be determined by an RMS (root mean square) value. It is understood that the RMS is the root mean square average of the profile height deviations from the mean line, recorded within the evaluation length. The RMS can be calculated based on the formula:

R_{q}=[(1/L)∫₀^{L}Z(x)²dx]^{-1/2},

wherein L defines an evaluation length and Z(x) defines the profile height function.

In some aspects, the surface of the article described herein has an RMS roughness of at least about 1 nm, at least about 5 nm, at least about 10 nm, at least about 15 nm, at least about 20 nm, at least about 25 nm, at least about 30 nm, at least about 35 nm, at least about 40 nm, at least about 45 nm, at least about 50 nm, at least about 55 nm, at least about 60 nm at least about 65 nm, at least about 70 nm, at least about 75 nm, at least about 80 nm, at least about 85 nm, at least about 90 nm, at least about 95 nm, at least about 100 nm, least about 105 nm, at least about 110 nm, at least about 115 nm, at least about 120 nm, at least about 125 nm, at least about 130 nm, at least about 135 nm, at least about 140 nm, at least about 145 nm, at least about 150 nm, at least about 155 nm, at least about 160 nm at least about 165 nm, at least about 170 nm, at least about 175 nm, at least about 180 nm, at least about 185 nm, at least about 190 nm, at least about 195 nm, and about 200 nm. It is further understood that the surface of the disclosed article can have any RMS value between any two foregoing RMS values.

In yet other aspects, the surface can have an RMS roughness of no greater than about 200 nm, no greater than about 195 nm, no greater than about 190 nm, no greater than about 185 nm, no greater than about 180 nm, no greater than about 175 nm, no greater than about 170 nm, no greater than about 165 nm, no greater than about 160 nm, no greater than about 155 nm, no greater than about 150 nm, no greater than about 145 nm, no greater than about 140 nm, no greater than about 135 nm, no greater than about 130 nm, no greater than about 125 nm, no greater than about 120 nm, no greater than about 115 nm, no greater than about 110 nm, no greater than about 105 nm, no greater than about 100 nm, no greater than about 95 nm, no greater than about 90 nm, no greater than about 85 nm, no greater than about 80, no greater than about 75, no greater than about 70 nm, no greater than about 65 nm, no greater than about 60 nm, no greater than about 55 nm, no greater than about 50 nm, no greater than about 45 nm, no greater than about 40 nm, no greater than about 35 nm, no greater than about 30 nm, no greater than about 25 nm, no greater than about 20 nm, no greater than about 15 nm, no greater than about 10 nm, no greater than about 5 nm, or about 1 nm. It is further understood that the surface of the disclosed article can have any RMS value between any two foregoing RMS values.

In some aspects, the etched surface has a water contact angle that is different than the surface's water contact angle prior to etching. In a further aspect, the etched surface has a water contact angle that is greater than the surface's water contact angle prior to etching. In a still further aspect, the etched surface has a water contact angle that is less than the surface's water contact angle prior to etching.

In some aspects, the etched surface can have a water contact angle of greater than about 90°, greater than about 95°, greater than about 100°, greater than about 105°, greater than about 110°, greater than about 120°, greater than about 125°, greater than about 130°, greater than about 135°, greater than about 140°, greater than about 145°, greater than about 150°, greater than about 155°, greater than about 160°, greater than about 165°, greater than about 170°, or greater than about 175°.

In yet other aspects, the etched surface can have a water contact angle no greater than about 90°, no greater than about 85°, no greater than about 80°, no greater than about 75°, no greater than about 70°, no greater than about 65°, no greater than about 60°, no greater than about 55°, no greater than about 50°, no greater than about 45°, no greater than about 40°, no greater than about 35°, no greater than about 30°, no greater than about 25°, no greater than about 20°, no greater than about 15°, no greater than about 10°, no greater than about 5°.

In some aspects, the etched surface is superhydrophilic. In yet other aspects, the etched surface is superhydrophobic.

In some aspects, the surface from which the particles are extending has a water contact angle that is different than the surface's water contact angle without the extending particles. In a further aspect, the surface from which the particles are extending has a water contact angle that is greater than the surface's water contact angle without the extending particles. In a still further aspect, the surface from which the particles are extending has a water contact angle that is less than the surface's water contact angle without the extending particles.

In some aspects, the surface can have a water contact angle of greater than about 90°, greater than about 95°, greater than about 100°, greater than about 105°, greater than about 110°, greater than about 120°, greater than about 125°, greater than about 130°, greater than about 135°, greater than about 140°, greater than about 145°, greater than about 150°, greater than about 155°, greater than about 160°, greater than about 165°, greater than about 170°, or greater than about 175°.

In yet other aspects, the surface can have a water contact angle no greater than about 90°, no greater than about 85°, no greater than about 80°, no greater than about 75°, no greater than about 70°, no greater than about 65°, no greater than about 60°, no greater than about 55°, no greater than about 50°, no greater than about 45°, no greater than about 40°, no greater than about 35°, no greater than about 30°, no greater than about 25°, no greater than about 20°, no greater than about 15°, no greater than about 10°, no greater than about 5°.

In some aspects, the surface is superhydrophilic. In yet other aspects, the etched surface is superhydrophobic.

It is further understood that the disclosed article can have one or more etched surfaces. In some aspect, the article can have a first etched surface and a second etched surface. In certain aspects, the first and second etched surfaces can have the same water contact angle. In yet other aspects, the first and second etched surface can have a different water contact angle. In some aspects, the first and second etched surfaces can have a water contact angle of greater than about 90°, greater than about 95°, greater than about 100°, greater than about 105°, greater than about 110°, greater than about 120°, greater than about 125°, greater than about 130°, greater than about 135°, greater than about 140°, greater than about 145°, greater than about 150°, greater than about 155°, greater than about 160°, greater than about 165°, greater than about 170°, or greater than about 175°. In yet other aspects, the first and second etched surface can have a water contact angle of no greater than about 90°, no greater than about 85°, no greater than about 80°, no greater than about 75°, no greater than about 70°, no greater than about 65°, no greater than about 60°, no greater than about 55°, no greater than about 50°, no greater than about 45°, no greater than about 40°, no greater than about 35°, no greater than about 30°, no greater than about 25°, no greater than about 20°, no greater than about 15°, no greater than about 10°, or no greater than about 5°.

In still further aspects, the first etched surface can have a water contact angle no greater than about 90°, no greater than about 85°, no greater than about 80°, no greater than about 75°, no greater than about 70°, no greater than about 65°, no greater than about 60°, no greater than about 55°, no greater than about 50°, no greater than about 45°, no greater than about 40°, no greater than about 35°, no greater than about 30°, no greater than about 25°, no greater than about 20°, no greater than about 15°, no greater than about 10°, no greater than about 5°, while the second etched surface can have greater than about 90°, greater than about 95°, greater than about 100°, greater than about 105°, greater than about 110°, greater than about 120°, greater than about 125°, greater than about 130°, greater than about 135°, greater than about 140°, greater than about 145°, greater than about 150°, greater than about 155°, greater than about 160°, greater than about 165°, greater than about 170°, or greater than about 175°.

In certain aspects, the first and second etched surface can comprise at least a first portion and at least a second portion. In some aspects, the at least a first portion of the first and/or second etched surface can have a water contact angle no greater than about 90°, no greater than about 85°, no greater than about 80°, no greater than about 75°, no greater than about 70°, no greater than about 65°, no greater than about 60°, no greater than about 55°, no greater than about 50°, no greater than about 45°, no greater than about 40°, no greater than about 35°, no greater than about 30°, no greater than about 25°, no greater than about 20°, no greater than about 15°, no greater than about 10°, no greater than about 5°. In yet other aspects, the at least a second portion of the first and/or second etched surface can have a water contact angle greater than about 90°, greater than about 95°, greater than about 100°, greater than about 105°, greater than about 110°, greater than about 120°, greater than about 125°, greater than about 130°, greater than about 135°, greater than about 140°, greater than about 145°, greater than about 150°, greater than about 155°, greater than about 160°, greater than about 165°, greater than about 170°, or greater than about 175°.

### C. METHODS

Disclosed herein are methods of making disclosed articles. It is understood that the particles can be embedded in the polymeric substrate by any methods known in the art. In some aspects, the particles are added to a melted polymeric substrate. In other aspects, the particles are added to a pelletized polymeric substrate. In these aspects, the mixture of the particles and the pelletized polymeric substrate is melted together to form a composite. In yet other aspects, the formed mixture can be blended to ensure homogeneous distribution of the particles in the substrate.

In certain aspects, the polymeric substrate and embedded particles can be molded to form an article. In yet other aspects, the polymeric substrate and embedded particles can be extruded.

In some aspects, the formed article is etched to expose at least a portion of the particles at the surface of the substrate. In some aspects, the etching can comprise any etching process known in the art. In yet other aspects, one of ordinary skill in the art can determine an etching process based on a specific polymeric substrate and/or particles. In some aspects, the etching process can comprise a solution based etching, plasma etching, or a combination thereof. In certain aspects, the etching comprises a solution based etching. In yet other aspects, the etching comprises plasma etching.

In certain aspects, the solution based etching comprises exposure of the article to one or more aqueous solution, organic solvents, organic acids and/or base, inorganic acids and/or base. It is understood that one of ordinary skill in the art can choose the specific solution based on a specific chemistry of the polymeric substrate. In some aspects, the solution comprises acetone, trichloroethylene, isopropyl alcohol, methanol, ethanol, tetrahydrofuran, n-methyl-2-pyrrolidone, or dimethylformamide, or any combination thereof.

In yet other aspects, the plasma etching comprising exposure of the article to plasma environment. It is further understood that one of ordinary skill in the art can chose specific plasma conditions, e.g. a type of plasma etch, a reactant gas, plasma power, etc. based on a specific chemistry of the polymeric substrate and/or the particles. In some aspects, plasma etch comprises using a reactive ion etching (RIE), a microwave plasma, inductively coupled plasma (ICP), electron cyclotron plasma (ECR), or any combination thereof. In some aspects, plasma etch can comprise use of an etchant gas. In certain aspects, the etchant gas can comprise oxygen, hydrogen, fluorocarbons, halogens, or any combination thereof.

In some aspects, the substrate surface can be masked to allow only a portion of the article to be etched. In these aspects, the article can comprise at least a portion of the substrate surface having exposed particles. It is further understood that such surface can have different hydrophobic/hydrophilic properties depending on what portion of the substrate comprises exposed particles. It is further understood that one of ordinary skill in the art can engineer level of hydrophobicity/hydrophilicity of various portions of the polymeric substrate by controlling surface etching and an amount and a type of the exposed particles.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

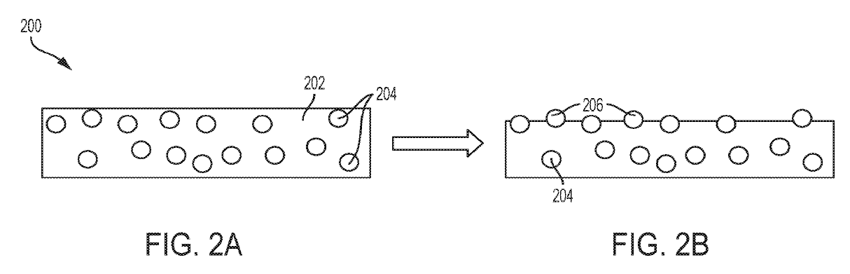

The article 200 comprising a composite material of the polymeric substrate 202 and the particles embedded within 204 is formed by molding (FIG. 2). The molded article is etched using a chemical etching or a plasma etching to expose at least a portion of the particles 206.

### 1. Example 1

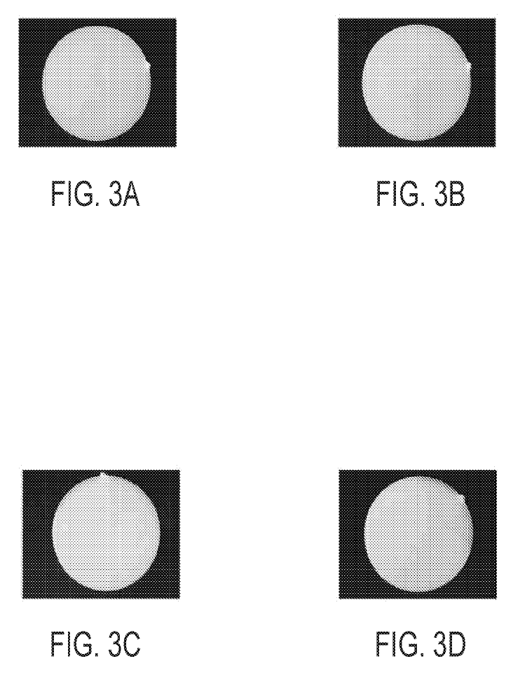

Polypropylene (PP) was utilized as a polymeric substrate. Hydrophobic polytetrafluoroethylene (PTFE) particles were added to the polymeric substrate at 200° C. and mixed to ensure homogeneous distribution of the particles in the substrate. The prepared composite was pelletized to the pellets with a length of 3 mm. The pellets then were poured into injection molding machine to form articles having a diameter of 5 cm and a thickness of 5 mm. FIG. 3A-D show the photographic images of the molded articles prepared by embedding various amounts of the polytetrafluoroethylene (PTFE) particles into the polypropylene (PP) polymeric substrate. FIG. 3A shows a photographic image of a control sample prepared from PP without presence of PTFE particles. FIG. 3B shows a photographic image of a sample prepared from the PP embedded with 1 wt % PTFE. FIG. 3C shows a photographic image of a sample prepared from the PP embedded with 5 wt % PTFE. FIG. 3D shows a photographic image of a sample prepared from the PP embedded with 10 wt % PTFE. Without wishing to be bound by theory, FIG. 3A-D demonstrate the presence of the embedded PTFE particles does not substantially affect the visual appearance of the articles.

### 2. Example 2

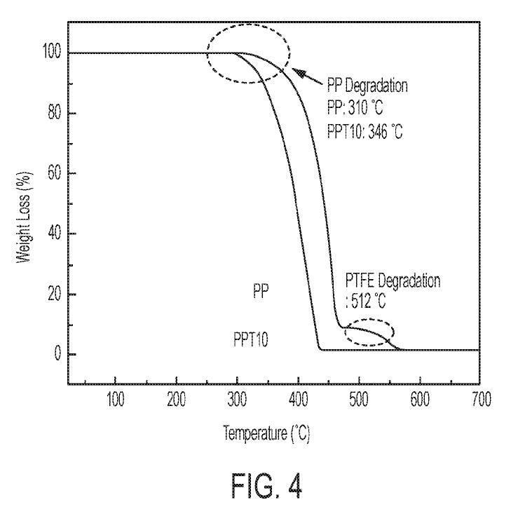

The composite was immersed in a trichloroethylene (C₂HCl₃) solvent that was used as an etchant to expose at least a portion of PTFE particles from the surface for 20 min, and then dried for 1 hour at 70° C. The thermal degradation of the resultant article was characterized with thermogravimetric analysis (TGA) (FIG. 4). It was found that a control sample of a pristine polypropylene (PP) has a 1^{st} degradation point at 310° C., while a sample comprising 10 wt % of the PTFE particles (PPT10) has a 1^{st} degradation point around 356° C. PPT10 also has a 2^{nd} degradation point at 512° C. corresponding to the degradation of PTFE. These results demonstrated that a PPT10 specimen is more thermally stable than a control sample comprising pristine PP due to incorporation of PTFE into polypropylene.

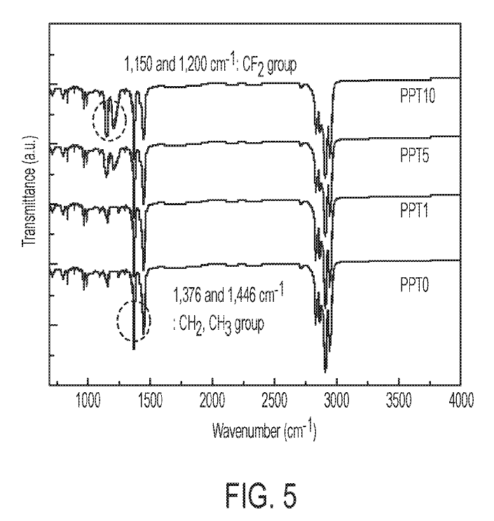

To further characterize the effect of PTFE particles embedded into polypropylene, the FTIR images of the etched surface were collected (FIG. 5). Addition of PTFE to the polymeric substrate resulted in appearance of CF₂ peaks (1,150 and 1,200 nm⁻¹) that are not visible for a control sample.

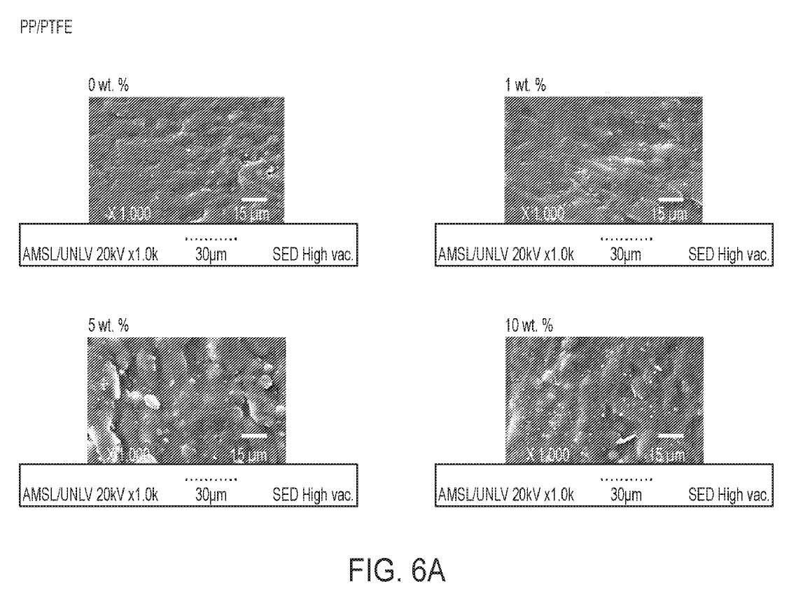

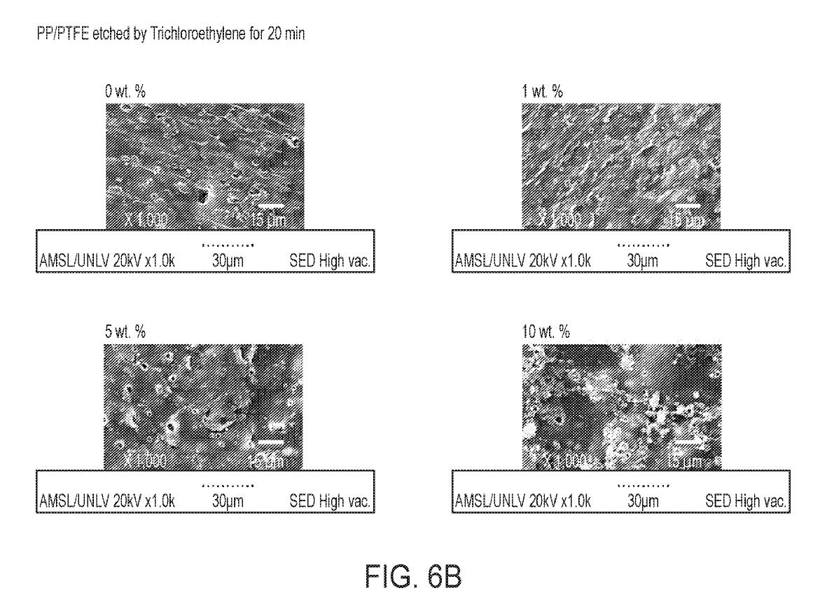

The surface morphology of the control sample and prepared composites was investigated by scanning electron microscopy (SEM) before (FIG. 6A) and after (FIG. 6B) surface etching. The control sample without etching showed a smooth surface. Increase in PTFE content showed roughening of the surface, and exposure of some of the PTFE particles on the surface. After etching, the surface of the prepared specimens became rougher and a large number of the PTFE particles was exposed by surface etching.

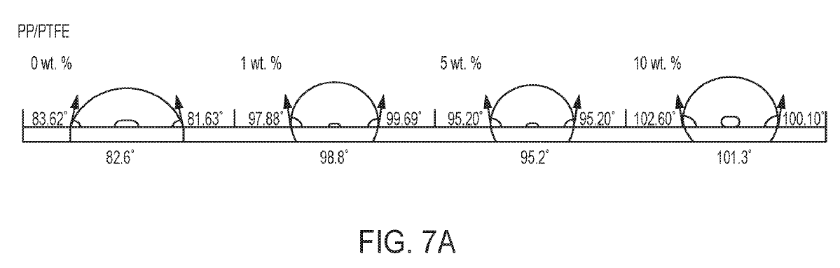

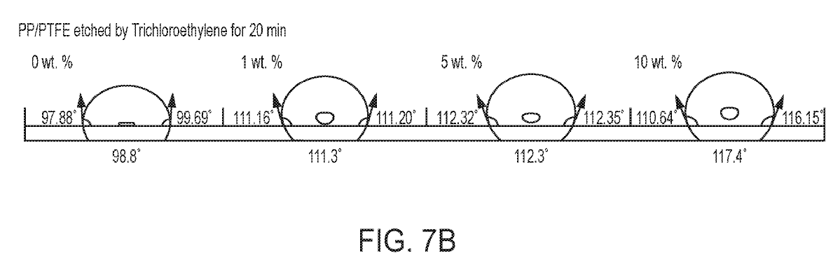

The water contact angle (WCA) of the control sample and sample comprising various amounts of the PTFE particles before (FIG. 7A) and after the etch (FIG. 7B) was measured to confirm variation in hydrophobicity. It was found that addition of the PTFE particles to the polymeric substrate resulted in an increase in the water contact angle from 83.6° to 101.3°. It was further observed that the solvent etching resulted in an increase in the water contact angle for all tested samples, demonstrating an increase in the overall hydrophobicity of the surface.

### 3. Example 3

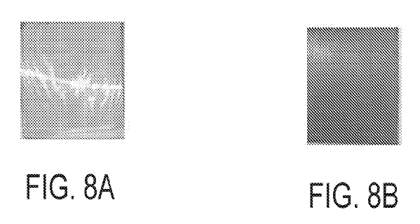

Polysulfone (PSf) was fully dissolved in N-Methyl-2-pyrrolidone (NMP) using a magnetic stirrer (150 rpm) at 40° C. for 6 hours. Next, PTFE particles were added by 1 wt % into the PSf solution, then mixed using a magnetic stirrer (150 rpm) at 40° C. for 3 hours. The resulting solution was cast in an aluminum mold (drying at 150° C. for 24 hours). The prepared composite was then mechanically etched using sand paper (grit#800) (FIG. 8A and FIG. 8B).

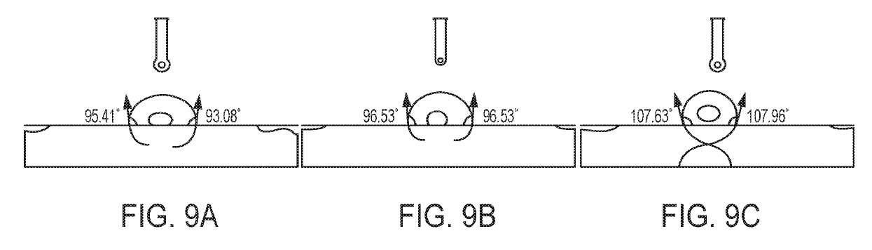

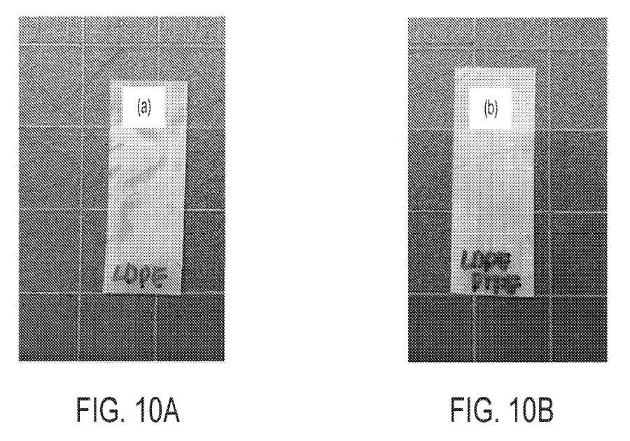

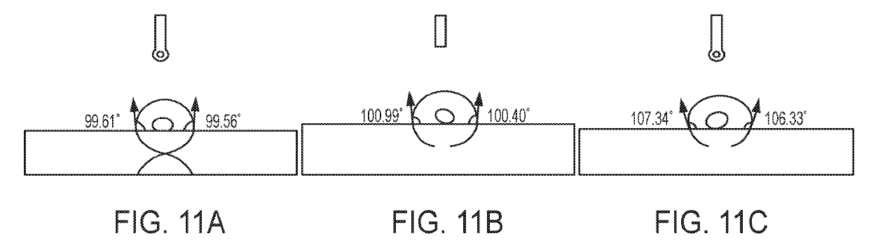

The WCA of pristine plastic and prepared composites with/without surface etching process was measured to confirm any variation in hydrophobicity (FIG. 9A-C). As the amount of PTFE particles in the plastic increases, the WCA increased from 94.50° to 96.53°. Additionally, the WCA further increased to 107.78° after etching the surface of the prepared composite.

### 4. Example 4

PTFE particle was mixed by 1 wt % in melted LDPE at 150° C. before being pelletized to a length of 3 mm. Pristine and composite films were prepared using the hot press method. Next, the pellet was poured into a hot plate mold and pressed (heating 150° C.). The specimens were then cooled and taken off of the mold. Finally, the resulting composite was mechanically etched using sand paper (grit#800).

The water contact angle (WCA) of the pristine plastic and prepared composites with/without surface etching process was measured to confirm variation of hydrophobicity. As the PTFE particles were added to the plastic, WCA increased from 98.09° to 100.70°. In addition, the water contact angle was further increased to 106.84° after etching.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An article comprising a substrate embedded with particles, wherein the substrate has at least one etched surface exposing at least a portion of the particles.

2. The article of claim 1, wherein the substrate comprises a polymeric substrate.

3. The article of claim 2, wherein the polymeric substrate comprises polypropylene (PP), low-density polyethylene (LDPE), high-density polyethylene(HDPE), polystyrenes (PS), acrylonitrile butadiene styrene (ABS), polyethylene terephthalate (PET), polyethylene (PE), polysulfone (PSf), or any combination thereof.

4. The article of claim 1, wherein the particles occupy at least about 20% of the substrate by volume.

5. The article of claim 1, wherein the particles are homogeneously distributed in the substrate.

6. The article of claim 1, wherein the article is not a film.

7. The article of claim 1, wherein the particles are hydrophobic particles.

8. The article of claim 7, wherein the particles comprise polytetrafluoroethylene particles, hydrophobic silica particles, titanium dioxide particles, or any combination thereof.

9. The article of claim 1, wherein the particles are hydrophilic particles.

10. The article of claim 9, wherein the particles comprise hydrophilic silica, titanium dioxide, polysilzane, or any combination thereof.

11. The article of claim 1, wherein the etched surface has a water contact angle that is different than the surface's water contact angle prior to etching.

12. The article of claim 1, wherein the etched surface has a water contact angle of greater than or equal to about 125°.

13. The article of claim 1, wherein the etched surface has a water contact angle of less than or equal to about 20°.

14. An article comprising a substrate having particles extending from a surface of the substrate.

15. The article of claim 14, wherein the particles occupy at least about 20% of the substrate by volume.

16. The article of claim 14, wherein the particles are homogeneously distributed in the substrate.

17. The article of claim 14, wherein the surface has a water contact angle of greater than or equal to about 125°.

18. The article of claim 14, wherein the surface has a water contact angle of less than or equal to about 20°.

19. A method comprising etching a surface of an article comprising particles embedded in a substrate.

20. The method of claim 19, wherein etching comprises a solution based etching, plasma etching, or a combination thereof.
